(19) United States
(12) Patent Application Publication
(10) Pub. No.: US 2017/0370723 A1
(43) Pub. Date: Dec. 28, 2017

(54) Electro-optical Phase Modulator Having Stitched-in Vacuum Stable Waveguide with Minimized Conductivity Contrast

(71) Applicant: The Charles Stark Draper Laboratory, Inc., Cambridge, MA (US)

(72) Inventor: Gilbert D. Feke, Windham, NH (US)

(21) Appl. No.: 15/633,795

(22) Filed: Jun. 27, 2017

Related U.S. Application Data
(60) Provisional application No. 62/355,397, filed on Jun. 28, 2016.

(51) Int. Cl. G01C 19/72; G02F 1/035; G02F 1/225; G02F 1/21

(52) U.S. Cl. CPC G01C 19/722; G02F 1/225; G02F 1/035; G02F 2201/06; G02F 2202/20; G02F 2001/211

(57) ABSTRACT

A Y-branch dual electro-optical phase modulator (YBDPM) has a stitched-in zinc oxide diffused waveguide. It is more vacuum stable and has higher resistance to photorefractive damage than currently used Ti-diffused waveguides. The YBDPM is useful in Fiber Optic Gyroscopes (FOG), especially in low frequencies applications.

### RELATED APPLICATIONS

This application claims the benefit under 35 USC 119(e) of U.S. Provisional Application No. 62/355,397, filed on Jun. 28, 2016, which is incorporated herein by reference in its entirety.

### GOVERNMENT SUPPORT

This invention was made with Government support under contract number N00030-16-C-0045, awarded by the U.S. Department of the Navy. The Government has certain rights in the invention.

### BACKGROUND OF THE INVENTION

Integrated optical circuits based on electro-optic phase modulators are well known in the art and are used in a variety of applications. The function of an electro-optic phase modulator is to transduce an electronic modulation signal received from an electrical circuit into phase modulation of a light beam traversing through its integrated optical waveguide.

Integrated optical waveguides are formed, for example, by diffusing a dopant material into a substrate such that a portion of the substrate comprises a diffused layer that has different light propagation characteristics than the original substrate. By controlling the depth and concentration of the diffused layer, a waveguide having desired optical propagation characteristics can be obtained. Prior art waveguides have been formed by diffusing titanium (Ti) or zinc oxide (e.g., ZnO, ZnLiNbO₄, or the like) into electro-optic materials such as lithium niobate (LiNbO₃) and lithium tantalate (LiTaO₃), as described, for example, in G. L. Tangonan, et al., “High optical power capabilities of Ti-diffused LiTaO₃ waveguide modulator structures,” Applied Physics Letters, Vol. 30, No. 5, Mar. 1, 1977, pp. 238-239; W. M. Young et al., “Photorefractive-damage-resistant Zn-diffused waveguides in MgO:LiNbO₃,” Optics Letters, Vol. 16, No. 13, Jul. 1, 1991, and U.S. Pat. No. 5,095,518 to Young et al, “Integrated optical waveguide utilizing zinc oxide diffused into congruent and magnesium oxide doped lithium niobate crystals”. Integrated optical waveguides have also been formed by vapor diffusion of zinc (Zn) into LiTaO₃, as illustrated, for example, in D. W. Yoon, et al., “Characterization of Vapor Diffused Zn:LiTaO₃ Optical Waveguides”, Journal of Lightwave Technology, Vol. 6, No. 6, June 1988, pp. 877-880. Such diffused waveguides guide all polarization states.

Still other integrated optical waveguides have been formed by proton exchange, as illustrated, for example, in P. G. Suchoski, et al., “Stable low-loss proton-exchanged LiNbO₃ waveguide devices with no electro-optic degradation”, Optics Letters, Vol. 13, No. 11, November 1988, pp. 1050-1052; J. J. Veselka, et al., “Low-insertion-loss channel waveguides in LiNbO₃ fabricated by proton exchange”, Electronics Letters, Vol. 23, No. 6, Mar. 12, 1987, pp. 265-266; J. Jackel, et al., “Damage-resistant LiNbO₃ waveguides,” Journal of Applied Physics, Vol. 55, No. 1, Jan. 1, 1984, pp. 269-270; and U.S. Pat. No. 4,948,407 to Bindell et al., “Proton exchange method of forming waveguides in LiNbO₃”. There have also been combinations of the diffusion and proton exchange techniques used in integrated optical components in order to obtain characteristics from both processes, as illustrated for example, in F. J. Leonberger, et al., “LiNbO₃ and LiTaO₃ Integrated Optic Components for Fiber Optic Sensors,” Optical Fiber Sensors, Proceedings of the 6th International Conference, OFS'89, Paris, France, Sep. 18-20, 1989, pp. 5-9; P. G. Suchoski, et al., “Low-loss high-extinction polarizers fabricated in LiNbO₃ by proton exchange”, Optics Letters, Vol. 13, No. 2, February 1988, pp. 172-174; and T. Findakly, et al., “Single-mode transmission selective integrated-optical polarisers in LiNbO₃”, Electronics Letters, Vol. 20, No. 3, Feb. 2, 1984, pp. 128-129. For many applications, proton-exchanged waveguides are used because waveguides formed of such material guide only one polarization state and thus serve as optical polarizers providing high polarization extinction ratio, which is the power ratio of light in the desired polarization state to the light in the undesired polarization state, as observed at the optical output.

Electrodes formed on the electro-optic material are connected to an electrical circuit that provides a modulation signal. Modulation is accomplished by varying an electric field across a portion of the waveguide. This varying electric field causes variations in the index of refraction for that portion of the waveguide, imparting a phase shift to the light beam. Proton-exchanged LiNbO₃ is widely used for optical phase modulators across several optical technology fields, such as communications and fiber optic gyroscopes, because it exhibits a desirable frequency response across a wide range of operating frequencies. That is, the gain of the modulator (i.e., the amplitude and phase shift of its output) is fairly flat (i.e., constant) over a wide frequency range of input signals.

A fiber optic gyroscope (FOG) uses the interference of light to measure angular velocity. Rotation is sensed in a FOG with a large coil of optical fiber forming a Sagnac interferometer. To measure rotation, two light beams are introduced into the coil in opposite directions by an electro-optic phase modulator such as a Y-branch dual phase modulator (YBDPM), as described for example in K. Kissa and J. E. Lewis, “Fiber-optic gyroscopes,” Chapter 23 from “Broadband Optical Modulators,” edited by Antao Chen and Ed Murphy, CRC Press, Boca Raton Fla., 2012, pp. 505-515, and in US Patent Application 2009/0219545, by Feth, “Stitched waveguide for use in a fiber-optic gyroscope”.

FIG. 1 shows a prior art Y-branch dual phase modulator (YBDPM) 100; and FIG. 2 shows a prior art fiber-optical gyroscope incorporating the YBDPM 100. If the coil 6 is undergoing a rotation, the beam traveling in the direction of rotation will experience a longer path to the other end of the fiber than the beam traveling against the rotation. This is known as the Sagnac effect. As the beams exit 5 the fiber they are combined at junction 110 in YBDPM 100. The resulting phase shift between the counter-rotating beams due to the Sagnac effect and modulation in the two branch sections of the YBDPM causes the beams to interfere, resulting in a combined beam, the intensity and phase of which depends on the angular velocity of the coil, and can be detected by a photodetector 3 as shown in FIG. 2. Because light of only one polarization is transmitted through the proton-exchanged waveguides of the integrated optical circuit, the precision of the FOG rate measurement is greatly increased. This yields the precision necessary for the most demanding navigation requirements.

YBDPM 100 is formed in LiNbO₃ substrate 101 and includes a single waveguide beam splitter/combiner in the form of a proton-exchanged waveguide Y-branch; this single Y-branch couples a first input/output waveguide portion 105 that terminates in a junction (Y-junction) 110 from which first and second branch waveguide portions 115, 120 are formed. First and second branch waveguide portions 115, 120 include respective bent regions 160, 165. Bent regions 160, 165 may have an angular “elbow” configuration as illustrated in FIG. 1, or may be configured with a less-severe, more rounded radius of curvature than that illustrated. First and second phase modulator sections 170, 175, each have modulating electrode pairs 135, 140, and are respectively coupled to second and third waveguide portions 125, 130. Each of electrode pairs 135, 140 provide respective modulating voltages generating respective electric fields. The electrode topology of the devices shown in FIG. 1 is conventionally found in X-cut LiNbO₃ modulators, with co-planar ground and signal electrodes disposed at the sides of each of the waveguide branches.

A problem exists, however, when attempting to use proton-exchanged LiNbO₃ for low frequency applications, especially where the optical modulator is exposed to high temperature or near vacuum or other desiccating environments. Under such conditions, the gain of the modulator for low frequency signals starts to diminish or otherwise vary from the high-frequency gain. The longer the modulator is exposed to vacuum, the more the degradations will continue to spread upward and affect higher frequencies. For communications applications, where signals are typically in the hundreds of megahertz, degradation of modulator performance at lower frequencies may not adversely affect performance. However, for navigation gyroscope applications that measure rotations starting in the sub-hertz range, such changes in the frequency response can render the gyroscope unacceptable for performing precise navigation functions.

In particular, when testing FOGs using a proton-exchanged LiNbO₃ electro-optic waveguide modulator in a vacuum environment, it has been found that a corruption of the electro-optic response occurred and grew with time, eventually rendering the FOG inoperable. The exact phenomenon that corrupts the response in FOG output is only partially understood and appears to involve ionic migration along the electric fields near the electrodes of the modulator.

In a LiNbO₃ electro-optic phase modulator, when a voltage is applied across a waveguide between electrodes parallel to the waveguide, the piezoelectric effect changes the spacing between the atoms in the poled molecules, which in turn changes the refractive index. This effect enables phase modulation, φ(t), where φ denotes phase and t denotes time, of an electromagnetic wave transiting the waveguide.

Normally, in a proton-exchanged LiNbO₃ electro-optic phase modulator the response of the refractive index to the electric field applied to the electrodes follows the voltage very accurately. However, after exposing to vacuum, the phenomenon called rate dependent sinusoids (RDS) manifests itself and corrupts the electro-optic response.

More specifically, the voltage V_{φ}(t) across the electrodes changes the phase of light in a waveguide by Δφ. During normal modulator operation in air, Δφ(t) follows the shape of the trace of V_{φ}(t) exactly as shown in FIGS. 4 and 5. After the modulator has been in vacuum for a nominal time, instead of following V_{φ}(t), φ(t) is corrupted, as shown in FIG. 6 as Δφ(t), and overshoots the desired Δφ at both the up and down voltage steps as shown.

As explained in US Patent Application 2009/0219545, by Feth, the electro-optic response of Ti-diffused waveguides is less affected by the presence of a vacuum than the electro-optic response of proton-exchanged waveguides. Therefore, in the prior art YBDPM 200 shown in FIG. 3, phase modulator sections 270, 275 utilize Ti-diffused waveguide portions 225, 230, which are shown as dotted lines in the figure. In the design of FIG. 3, Ti-diffused waveguide portions are stitched in between a respective first proton-exchanged waveguide section 280 comprising proton-exchanged waveguide portions 115, 120, and second and third proton-exchanged waveguide portions 245, 250, in the region where the electrode pairs apply electric fields to the waveguides. The various proton-exchanged waveguide portions are shown in FIG. 3 as thick solid lines. The proton-exchanged waveguide portions on either side of the Ti-diffused waveguide portions help to reduce any degradation of chip polarization extinction ratio due to the Ti-diffused waveguide portions.

When YBDPM 100 or 200 is used in a FOG, each of the phase modulator sections 170, 175 or 270, 275, respectively, is modulated with a periodic or aperiodic waveform in a frequency range that may extend from as low as 10⁻⁶ Hz to about 1 MHz. Typical waveform patterns include sawtooth waves such as serrodyne waveform, square waves, or triangular waves with a period ranging typically from 1 microsecond (μs) to 10⁶ seconds. For good performance of the FOG, it is required the optical phase of light at the output of respective phase modulator sections 170, 175 or 270, 275 has a one-to-one correspondence with the voltage that is applied to the electrode pairs 135, 140 to induce an electrical field in the waveguides.

The use of stitched-in Ti-diffused waveguides in the phase modulator sections of YBDPM 200 as described by Feth does appear to improve the device performance. However, it has been found that the electro-optic response of YBDPM 200 still suffers from non-idealities resulting in a non-flat step response (FIG. 6), when the optical phase shift in the waveguide continues to change for minutes after a step-wise change in an applied voltage to a new DC level, and a non-flat frequency response of electro-optic characteristics at frequencies at or below about 1 Hz.

Another limitation of Ti-diffused waveguides is that their susceptibility to photorefractive degradation, light-induced refractive index changes that lead to scattering. The photorefractive effect is a result of the photoconductivity of the waveguide material. Electrons can absorb light and be photoexcited from an impurity level into the conduction band of the material (photoexcited states), leaving an electron hole (a net positive charge). Impurity levels have an energy intermediate between the energies of the valence band and conduction band of the material. Once in the conduction band, the electrons are free to move and diffuse throughout the crystal. Since the electrons are being excited preferentially in the illuminated regions of the material, the net electron diffusion current is towards the dark regions of the material. While in the conduction band, the electrons may with some probability recombine with the holes and return to the impurity levels. The rate at which this recombination takes place determines how far the electrons diffuse, and thus the overall strength of the photorefractive effect in that material. Once back in the impurity level, the electrons are trapped and can no longer move unless re-excited back into the conduction band (by light). With the net redistribution of electrons into the dark regions of the material, leaving holes in the illuminated regions, the resulting charge distribution causes an electric field, known as a space charge field to be set up in the crystal. Since the electrons and holes are trapped and immobile, the space charge field persists even when the illumination is removed. The internal space charge field, via the electro-optic effect, causes the refractive index of the crystal to change in the regions where the field is strongest. This causes a spatially varying refractive index, and hence scatter, within the material. The refractive-index changes show a characteristic dependence on the light intensity that can be explained by a nonlinear behavior of the photoconductivity. Photorefractive degradation of the stitched-in Ti-diffused waveguides in YBDPM 200 may result in undesirable changes of insertion loss, wavelength dependent loss, and polarization extinction ratio over time during operation.

The susceptibility of Ti-diffused waveguides to photorefractive degradation is relatively high compared to proton-exchanged waveguides. This is due to the increased dark (thermally-dependent) conductivity that results from the proton-exchange process. Increased dark conductivity corresponds to increased competition between thermally excited states and photoexcited states. As reported in T. Fujiwara et al., “Comparison of photorefractive index change in proton-exchanged and Ti-diffused LiNbO₃ waveguides,” Optics Letters, Vol. 18, No. 5, Mar. 1, 1993, pp. 346-348, the dark conductivity of proton-exchanged waveguides ranges from 0.6×10⁻¹⁴ to 1.5×10⁻¹⁴ Ω⁻¹·cm⁻¹ compared to that of Ti-diffused waveguides (<0.01×10⁻¹⁴ Ω⁻¹·cm⁻¹).

### SUMMARY OF THE INVENTION

Thus, there remains a need for vacuum-stable stitched-in waveguides for integrated optical circuits based on LiNbO₃ electro-optic phase modulators with improved step response and improved frequency response of electro-optic characteristics, especially at frequencies at or below about 1 Hz. Further, there remains a need for stitched-in vacuum-stable waveguides for integrated optical circuits based on LiNbO₃ electro-optic waveguide modulators with reduced susceptibility to photorefractive degradation.

Accordingly, the present invention relates to an integrated optical circuit based on LiNbO₃ electro-optic waveguide modulators for use in low-frequency applications, for example, that has a substantially flattened electro-optic step response and a substantially flattened electro-optic frequency response, especially at frequencies at or below about 1 Hz, and further exhibits substantially reduced susceptibility to photorefractive degradation.

The present invention can provide an electro-optical phase modulator integrated optical circuit comprising: a proton-exchanged waveguide portion, first and second stitched-in vacuum-stable waveguide portions, and first and second modulator sections. The proton-exchanged waveguide portion comprises an input/output waveguide section terminating in a junction section from which first and second branch sections are formed. First and second stitched-in vacuum-stable waveguide portions have minimized conductivity contrast with respect to the LiNbO₃ host material, and are respectively coupled to the first and second branch sections for providing a substantially flattened electro-optic step response and a substantially flattened electro-optic frequency response, especially at frequencies at or below about 1 Hz, and further for providing substantially reduced susceptibility to photorefractive degradation. First and second modulator sections are respectively coupled to the first and second stitched-in waveguide portions. Each of the modulator sections provides respective modulating voltages generating respective electric fields. The first and second stitched-in vacuum-stable waveguide portions are coupled to the first and second branch sections at respective locations where the electric fields are substantially zero.

Additional features and advantages will be set forth in the detailed description which follows, and in part will be readily apparent to those skilled in the art from the description or recognized by practicing the embodiments as described in the written description and claims hereof, as well as the appended drawings.

In general, according to one aspect, the invention features an optical phase modulator. It comprises a lithium niobate substrate, a proton-exchanged waveguide section formed on the substrate, and a zinc oxide diffused stitched-in waveguide section formed on the substrate and optically coupled to the proton-exchanged waveguide section

In an illustrated embodiment, an electrode pair is formed on either side of the zinc oxide diffused stitched-in waveguide section on the substrate.

In embodiments, the proton-exchanged waveguide section comprises a Y-junction, a first branch waveguide portion, and a second branch waveguide portion.

The zinc oxide diffused stitched-in waveguide section comprises a first stitched-in waveguide portion optically coupled to the first branch waveguide portion, a second stitched-in waveguide portion optically coupled to the second branch waveguide portion and a plurality of electrodes proximate to the first and second stitched-in waveguide portions.

Preferably, the proton-exchanged waveguide section further comprises a first distal side waveguide portion optically coupled to the first stitched-in waveguide portion; and a second distal side waveguide portion optically coupled to the second stitched-in waveguide portion.

The first and second zinc oxide diffused stitched-in waveguide portions should extend substantially parallel to crystal planes of the substrate.

Coupling locations between the zinc oxide diffused stitched-in waveguide section and the proton-exchanged waveguide section should be separated from the plurality of electrodes by greater than 0.1 mm.

In general, according to another aspect, the invention features a fiber optic gyroscope. This gyroscope comprises a light source for generating light, a fiber coil through which the light is transmitted, and an optical phase modulator for modulating the light. The optical phase modulator includes a lithium niobate substrate, a proton-exchanged waveguide section formed on the substrate, and a zinc oxide diffused stitched-in waveguide section formed on the substrate and optically coupled to the proton-exchanged waveguide section.

In general, according to still another aspect, the invention features a method of fabricating an optical phase modulator. The method comprises providing a lithium niobate substrate, forming a proton-exchanged waveguide section on the substrate, and forming a zinc oxide diffused stitched-in waveguide section that is optically coupled to the proton-exchanged waveguide section.

Preferably, forming the proton-exchanged waveguide section comprises forming a Y-junction, forming a first branch waveguide portion, and forming a second branch waveguide portion. Further, forming the zinc oxide diffused stitched-in waveguide section preferably comprises forming a first stitched-in waveguide portion that is optically coupled to the first branch waveguide portion, forming a second stitched-in waveguide portion that is optically coupled to the second branch waveguide portion, and forming a plurality of electrodes proximate to the first and second stitched-in waveguide portions.

Forming the proton-exchanged waveguide section preferably further comprises forming a first distal side waveguide portion that is optically coupled to first stitched-in waveguide portion; and forming a second distal side waveguide portion that is optically coupled to second stitched-in waveguide portion.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a top view of a prior art Y-branch dual phase modulator (YBDPM);

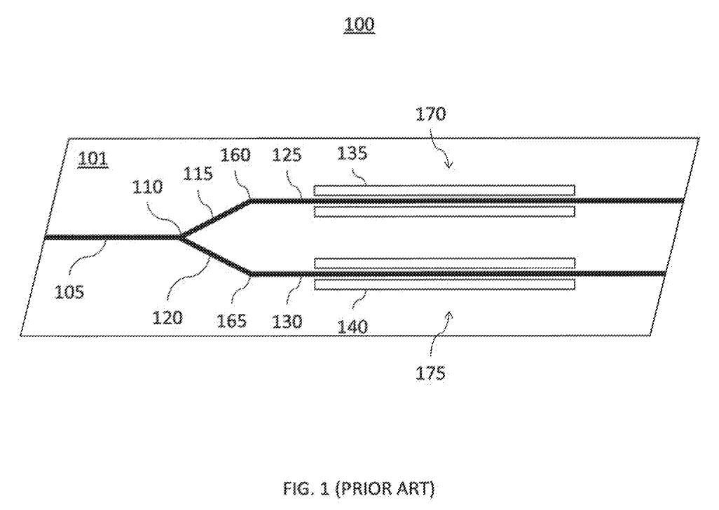

FIG. 2 is a schematic diagram of a prior art fiber-optical gyroscope incorporating the YBDPM of FIG. 1;

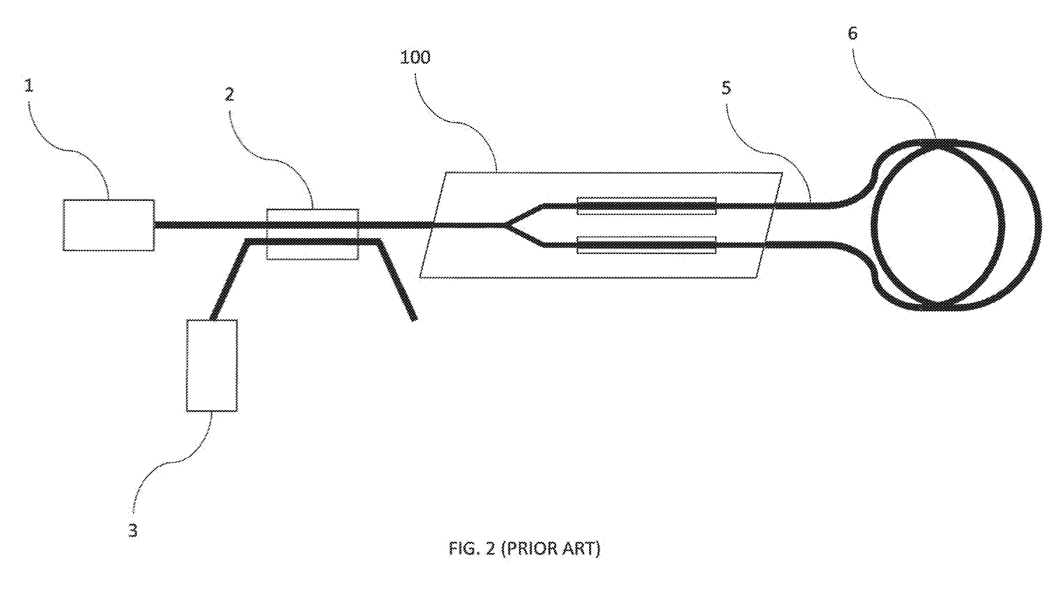

FIG. 3 is a top view of a prior art YBDPM comprising titanium (Ti) diffused stitched-in waveguide portions;

FIG. 4 is a graph showing a step in a voltage applied to the YBDPM of FIG. 3;

FIG. 5 is a graph showing an electro-optic response of an ideal YBDPM to the voltage step of FIG. 4;

FIG. 6 is a graph showing an exemplary electro-optic response of the prior art YBDPM of FIG. 3 to the voltage step of FIG. 4 according to measurements at or below 1 Hz.;

FIG. 7 is a graph illustrating an exemplary electro-optic frequency response, represented as Vpi(f), where Vpi is voltage and f is frequency, of the prior art YBDPM of FIG. 3 to the voltage step of FIG. 4 according to measurements;

FIG. 8 is a top view of a YBDPM comprising stitched-in vacuum-stable waveguide portions with minimized conductivity contrast according to an embodiment of the present disclosure; and

FIG. 9 is a schematic diagram of a fiber-optical gyroscope incorporating an YBDPM according to an embodiment of the present disclosure.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Where they are used, the terms “first”, “second”, and so on, do not denote any ordinal or priority relation, but are simply used to more clearly distinguish one element from another. The term “low frequency” with reference to an electro-optic frequency response or modulation efficiency means herein frequencies from about 1 Hz down to 0.00001 Hz or less, unless stated otherwise. The term ‘low-frequency application’ is used herein to mean applications wherein the device is modulated at frequencies generally below about 1 MHz and including frequencies in the range from about 1 Hz down to 0.00001 Hz or less, unless stated otherwise.

There is a need for stitched-in waveguides for integrated optical circuits based on LiNbO₃ electro-optic phase modulators with improved flattened step response and improved flattened frequency response of electro-optic characteristics, especially at frequencies at or below about 1 Hz. Further, there is a need for stitched-in waveguides for integrated optical circuits based on LiNbO₃ electro-optic phase modulators with reduced susceptibility to photorefractive degradation.

Prior to providing a detailed description of exemplary embodiments, some drawbacks of prior art YBDPM devices are described, in particular non-idealities in their time-domain and frequency-domain EO responses.

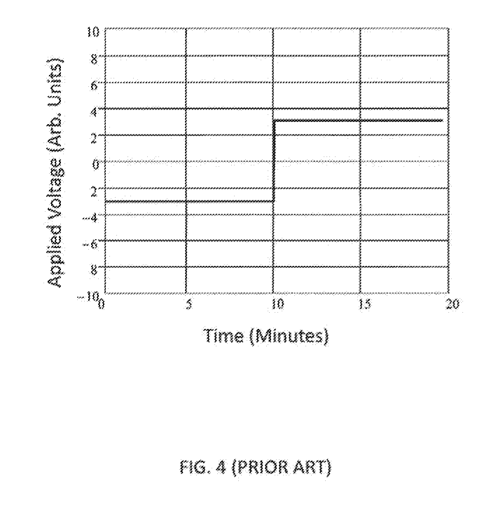

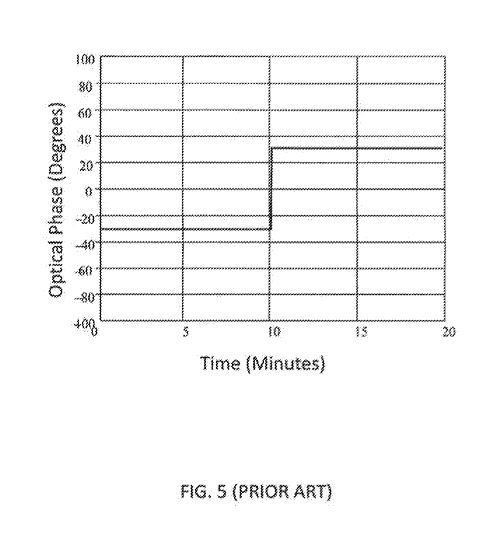

More specifically, a step-wise change in the voltage applied to the electrode pairs 135, 140 should ideally generate a flat step-wise change in the output optical phase. This is illustrated in FIGS. 4 and 5, wherein FIG. 4 shows a plot of applied voltage vs. time, where the voltage units are arbitrary and the time units are minutes, while FIG. 5 describes the ideal electro-optic step response, i.e. the time-dependence of the optical phase at the output of a modulator section when the applied voltage is stepped from one DC voltage level to another as in FIG. 4. In the ideal electro-optic step response of FIG. 5, the optical phase at the outputs of the modulator stays substantially constant, i.e. ‘flat’, a second or less after the applied voltage is set to a new value, and remains constant for minutes or more. The term “step response” or “electro-optic step response” is used herein to mean a time-domain response of the optical phase accrued in a phase modulator to a step in the applied DC voltage. FIG. 5 shows an approximate 60 degree abrupt change in differential optical phase. The actual magnitude of the phase change depends on the applied voltage and the Vpi of the modulator. Parameter Vpi, also denoted Vπ, is defined as the applied voltage required to produce a 180 degree (or π radians) change in the optical phase at the output of an electro-optic modulator. For an ideal electro-optic step response, the step change in the optical phase is flat with time, that is, there is no sign of any relaxation or amplification of the optical phase with time seconds after the abrupt change in the applied voltage.

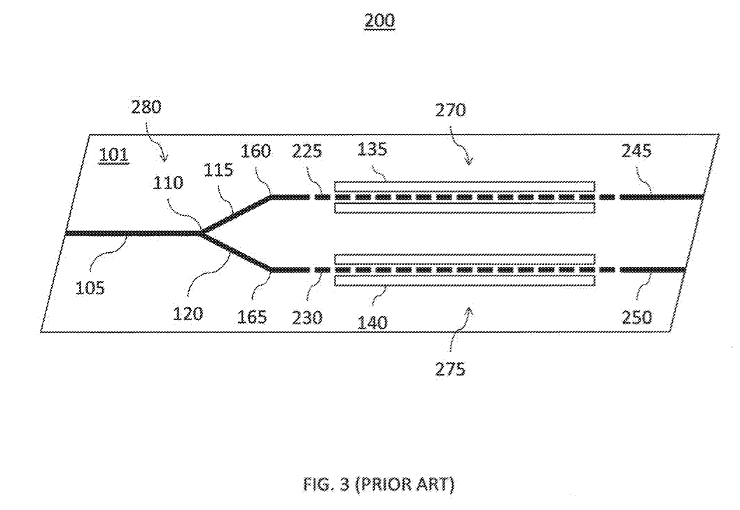

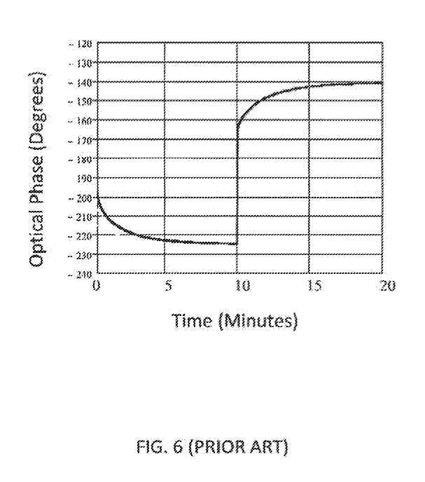

It has been observed, however, that the real-world behavior of the phase change in the YBDPM 200 comprising stitched-in Ti-diffused waveguides differs from the ideal response illustrated in FIG. 5. More specifically, FIG. 6 shows the measured optical phase vs. time behavior for the YBDPM 200 of FIG. 3 with Ti-diffused waveguides in the electrode region, where the applied voltage with time has the same shape as the plot shown in FIG. 4. The modulator temperature was 70° C. Note that the optical phase change grows with time after the step change in applied voltage, before finally leveling off after about 17 minutes. The time constant for the leveling off appears to be greater than one minute. The continuing change in the optical phase after the new voltage is set is a clear disadvantage for applications that require a fixed optical phase change in the waveguide with time for a fixed voltage.

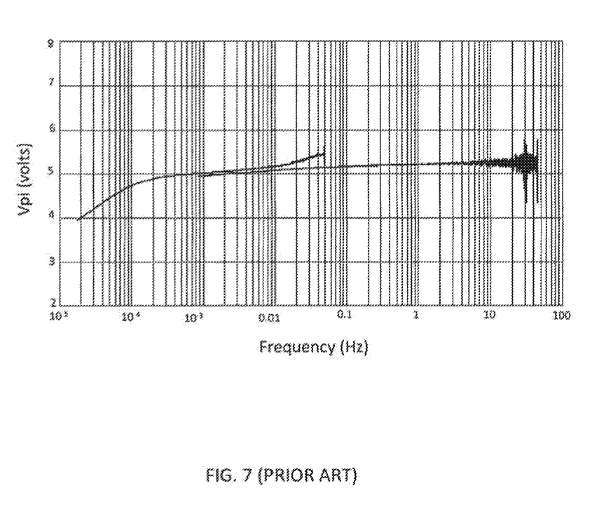

FIG. 7 shows a measured electro-optic frequency response, represented in this particular figure as Vpi vs. modulation frequency, for a phase modulator with Ti-diffused waveguide. The electro-optic frequency response may be determined by the ratio of the Fast Fourier Transform (FFT) of the electro-optic step response as shown in FIG. 6 to the FFT of the applied voltage waveform as shown in FIG. 4. The Vpi is proportional to the inverse of this ratio. Multiple steps of different durations can be applied to produce frequency content over a broad frequency range. Step response to voltage steps having short duration are measured with faster sample rates (90 Hz), whereas step response to voltage steps with long duration are sampled at a slow rate (0.1 Hz). Two curves shown in FIG. 7 are generated due to the two sets of sampling rates. There is a discontinuity between the curves in the frequency region of 0.01 Hz to 0.1 Hz, which is an artifact of the data analysis method and is related to the uncertainty in the measured value derived from the 0.1 Hz sample rate. Square shaped voltages with long duration sampled with 0.1 Hz sample rate have only a small amount of frequency content near the sample rate, causing the derived frequency response to be more affected by noise and other uncertainties. Similarly, the response near 10 Hz, which is derived from data taken at the 90 Hz sample rate, becomes affected by noise, causing some oscillation in the derived response near 10 Hz. The oscillations are not real, but an artifact of the measurement and data analysis method.

The ideal flat step response that is illustrated in FIG. 5 would correspond to a flat frequency response with a frequency-independent Vpi, i.e. as would be represented by a horizontal line in FIG. 7. Instead as can be clearly seen from FIG. 7, measured Vpi is frequency-dependent and decreases as modulation frequency f decreases, falling as much as 40% at f˜10⁻⁵ Hz relative to f˜1 Hz, for temperature of 70° C.

The present disclosure addresses this drawback of the prior art integrated optical circuits, such as YBDPMs, by providing means to flatten both the frequency domain electro-optic response at sub-Hz frequencies, and the time-domain step response. In one aspect of the present invention, the response is flattened by the use of stitched-in vacuum-stable waveguide portions with minimized conductivity contrast.

It is a hypothesis that the low conductivity of stitched-in Ti-diffused waveguide portions relative to the LiNbO₃ host material results in a relatively large magnitude conductivity contrast that contributes to the non-flat step response and non-flat frequency response of the electro-optic characteristics in prior art integrated optical circuits, such as YBDPMs, at frequencies at or below about 1 Hz, and that by instead using vacuum-stable waveguides with minimized conductivity contrast as the stitched-in portions the integrated optical circuit will exhibit a substantially flattened electro-optic step response and a substantially flattened electro-optic frequency response, especially at frequencies at or below about 1 Hz, and further will exhibit substantially reduced susceptibility to photorefractive degradation.

Examples of vacuum-stable waveguide materials with high resistance to photorefractive damage, and hence higher conductivity than Ti-diffused waveguides, are zinc oxide diffused waveguides in both LiNbO₃ and magnesium oxide (MgO) doped LiNbO₃. Therefore zinc oxide diffused waveguides provide the opportunity to minimize conductivity contrast and hence to flatten step response and frequency response.

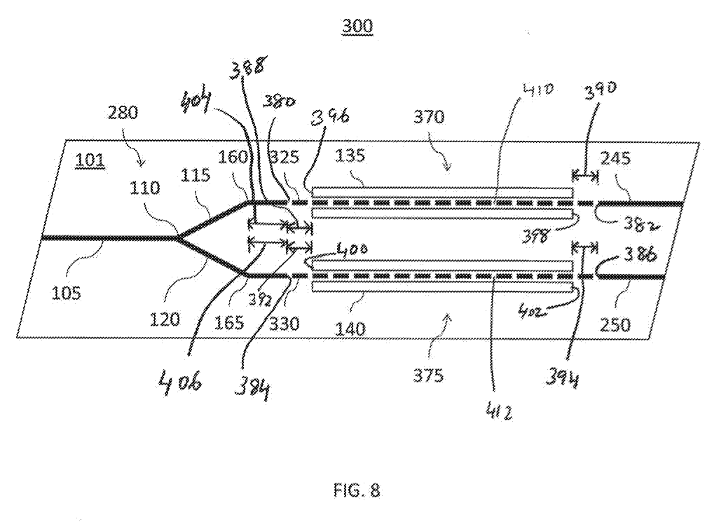

With reference to FIG. 8, one embodiment of the present disclosure provides an YBDPM 300 for use in low-frequency applications such as FOGs.

In more detail, the YBDPM 300 is formed in a LiNbO₃ or a magnesium oxide (MgO) doped LiNbO₃ substrate 101. The substrate is X-cut.

YBDPM 300 is generally similar in topology to the YBDPM 200, but phase modulator sections 370, 375 utilize first and second stitched-in vacuum-stable waveguide portions with minimized conductivity contrast 325, 330, for example. The first and second stitched-in vacuum-stable waveguide portions 325, 330 are zinc oxide diffused waveguides, which are shown as dotted lines in the figure. In the design of FIG. 8, the vacuum-compatible waveguides with minimized conductivity contrast are stitched in after proton-exchanged first and second branch waveguide portions 115, 120, that are shown as thick solid lines are fabricated. The first and second stitched-in vacuum-stable waveguide portions 325, 330 located in the region where the electrode pairs apply electric fields to the waveguides.

In proton exchange process, the Lithium ions (Li+) are replaced by protons (i.e., H+ hydrogen ions). The proton-exchanged waveguide portion reduces any degradation of chip polarization extinction ratio due to the stitched-in waveguide portions.

More particularly, YBDPM 300 is an integrated optical circuit comprising: a first proton-exchanged waveguide section 280, first and second stitched-in vacuum-stable waveguide portions with minimized conductivity contrast 325, 330, and first and second modulator sections 370, 375. First proton-exchanged waveguide section 280 comprises an input/output waveguide portion 105 terminating in junction (Y-junction) 110 from which first and second branch waveguide portions 115, 120 are formed. First and second stitched-in waveguide portions 325, 330 are respectively coupled to the first and second branch waveguide portions 115, 120 for providing a substantially flattened electro-optic step response and a substantially flattened electro-optic frequency response, especially at frequencies at or below about 1 Hz, and further for providing substantially reduced susceptibility to photorefractive degradation. First and second phase modulator sections 370, 375 comprise electrode pairs 135, 140 that are respectively coupled to first and second stitched-in waveguide portions 325, 330. Each of electrode pairs 135, 140 are typically metal layers that have been deposited on the substrate. Each of electrode pairs 135, 140 provides modulating voltages generating respective electric fields.

First and second stitched-in waveguide portions 370, 375 are coupled to first and second branch waveguide portions 115, 120 at respective coupling locations 380, 382, 384, 386 where the electric fields are substantially zero. In more detail, the proton-exchanged branch waveguide portion 115 optically couples to the zinc oxide diffused stitched-in waveguide portion 325 at coupling location 380, and zinc oxide diffused stitched-in waveguide portion 325 optically couples to the proton-exchanged second waveguide portion 245 at coupling location 382, on the distal side of the first electrode pairs 135. Similarly on the other branch, the proton-exchanged branch waveguide portion 120 optically couples to the zinc oxide diffused stitched-in waveguide 330 at coupling location 384, and zinc oxide diffused stitched-in waveguide 330 optically couples to the proton-exchanged third waveguide portion 250 at coupling location 386 on the distal side of the second electrode pairs 140.

As such, the stitching occurs far enough from the electrode pairs 135, 140 such that first proton-exchanged waveguide section 280 is unaffected by electric fields associated with modulation voltages. Specifically, at this distance, the electric fields are attenuated compared to the electric fields in the gaps 410 and 412 between the respective first electrode pairs 135 and the second electrode pairs 140.

In more detail, the coupling locations 380, 382, 384, 386 are spaced away from the nearest edge of the electrode pairs 135, 140 to reduce exposure to their electric fields. In more detail, coupling location 380 is separated by a distance 388 from the two leading edges 396 of the first electrode pair 135; and coupling location 382 is separated by a distance 390 from the two trailing edges 398 of the first electrode pair 135. On the other branch, coupling location 384 is separated by a distance 392 from the two leading edges 400 of the second electrode pair 140; and coupling location 386 is separated by a distance 394 from the two trailing edges 402 of the second electrode pair 140.

For most embodiments, each of the distances 388, 390, 392, 394 is greater than 0.1 mm. Preferably, each of the distances 388, 390, 392, 394 is greater than 0.5 mm.

Additionally, and preferably, the respective coupling locations 380, 384 between first and second branch waveguide portions 115, 120 and first and second stitched-in waveguide portions 325, 330 are approximately halfway between the leading edges 396, 400 of electrodes 135, 140 and the bent regions 160, 165. As such, the stitching occurs a distance away from the bent regions 160, 165 sufficient to avoid modal transition effects that may occur at the bent regions. In more detail, the distance 404 between bent region 160 and the coupling region 380 is approximately equal to distance 388, and the distance 406 between bent region 165 and the coupling region 384 is approximately equal to distance 392.

For most embodiments, each of the distances 404 and 406 is greater than 0.1 mm. Preferably, each of the distances 404 and 406 is greater than 0.5 mm.

Further advantages to the approach illustrated in FIG. 8 may be described in the following context:

Linearly polarized light propagating along the fast or slow axis of a birefringent material such as LiNbO₃ will remain in that axis, as coupling between the axes cannot occur for the reason that it is not possible to phase match the light in both beams simultaneously.

Since waveguides may be physically formed by well-known processes for diffusing waveguide material along the crystal planes which develop the birefringence in the crystal, the angular alignment between the fast and slow axes of the stitched waveguides is virtually perfect, a property that maintains the very high extinction ratio provided by the proton-exchanged waveguides.

In anisotropic substances such as a birefringent crystal, electric vectors oscillate normal to the propagation vector in orthogonal planes (H and V). The azimuths and refractive indices of H and V are determined by the stoichiometric arrangement of the molecules comprising the crystal. The refractive index is proportional to the area density of atoms in the respective H and V planes (viz., atoms/mm²), the birefringence is proportional to the difference of the refractive indices along the planes.

In the embodiment illustrated in FIG. 8, the stitching (coupling regions 380, 382, 384, 386) occurs in portions of the waveguides that are parallel, or very nearly parallel, to the crystal planes of the substrate 101. Specifically, the first stitched-in waveguide portion 325 and the second stitched-in waveguide portion 330 each extend substantially parallel to crystal planes of the substrate 101.

Moreover, the LiNbO₃ crystal planes determine the alignment of both the birefringent axes in diffused waveguides, and the pass axis of the light in proton-exchanged waveguides. This makes the angular alignment at the stitch nearly perfect, thus avoiding gyroscope rate errors due to angular misalignments in the integrated optical circuit.

Additionally, the extinction ratio of the stitched waveguide integrated optical circuit 300, which includes polarizing proton-exchanged waveguides and vacuum-stable diffused waveguides with minimized conductivity contrast, is substantially the same as that of a purely proton-exchanged integrated optical circuit.

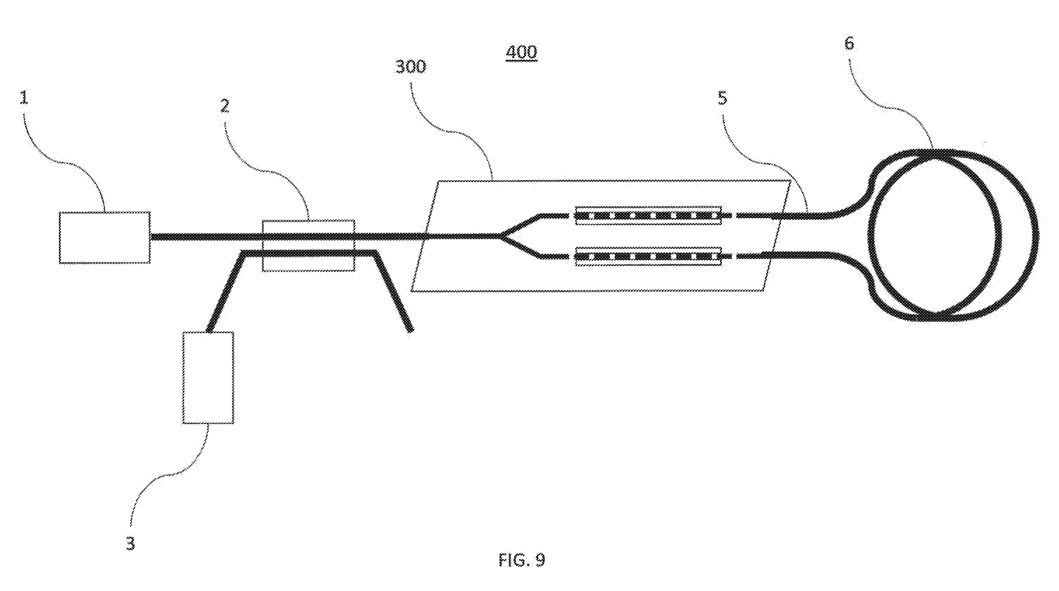

Turning now to FIG. 9, there is schematically illustrated a rotation sensor in the form of a fiber optic gyroscope (FOG) 400 that incorporates YBDPM 300 in accordance with an embodiment of the present disclosure. An optical source 1, typically a laser, light emitting diode (LED), or other suitable light source, provides light that travels through a fiber-optic coupler 2 and through YBDPM 300 to a fiber coil 6, entering the fiber coil 6 simultaneously at both ends 5 thereof. The FOG 400 senses rotation via the Sagnac effect as described, for example, in K. Kissa and J. E. Lewis, “Fiber-optic gyroscopes,” Chapter 23 from “Broadband Optical Modulators,” edited by Antao Chen and Ed Murphy, CRC Press, Boca Raton Fla., 2012, pp. 505-515. Rotation of the fiber coil 6 causes a non-reciprocal phase shift between the counterclockwise and counterclockwise propagating optical beams in the fiber coil 6. This non-reciprocal phase shift in the fiber coil 6, together with the phase modulation in the YBDPM 300, creates a change in light intensity at the photodiode 3 due to coherent interference of the two beams as they merge in the Y-junction 110 of the YBDPM 300 after transit in the fiber coil 6. The effect of phase modulation is non-reciprocal, as well, due to the transit time through the fiber coil, hence it can be used to interact with the non-reciprocal phase shift produced by rotation. The photodiode 3 produces an electrical signal proportional to the intensity of the received light, and variations in that signal provide an indication of the angular rotation speed of the fiber coil 6. The fiber-optic coupler 2 can be an evanescent directional coupler or an optical circulator.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention.

What is claimed is:

1. An optical phase modulator, comprising:
a lithium niobate substrate;
a proton-exchanged waveguide section formed on the substrate; and
a zinc oxide diffused stitched-in waveguide section formed on the substrate and optically coupled to the proton-exchanged waveguide section.

2. A modulator as claimed in claim 1, wherein the proton-exchanged waveguide section comprises a Y-junction, a first branch waveguide portion, and a second branch waveguide portion.

3. A modulator as claimed in claim 2, wherein the zinc oxide diffused stitched-in waveguide section comprises a first stitched-in waveguide portion optically coupled to the first branch waveguide portion, a second stitched-in waveguide portion optically coupled to the second branch waveguide portion, and a plurality of electrodes proximate to the first and second stitched-in waveguide portions.

4. A modulator as claimed in claim 3, wherein the proton-exchanged waveguide section further comprises a first distal side waveguide portion optically coupled to the first stitched-in waveguide portion; and a second distal side waveguide portion optically coupled to the second stitched-in waveguide portion.

5. A modulator as claimed in claim 3, wherein the first and second zinc oxide diffused stitched-in waveguide portions extend substantially parallel to crystal planes of the substrate.

6. A modulator as claimed in claim 3, wherein coupling locations between the zinc oxide diffused stitched-in waveguide section and the proton-exchanged waveguide section are separated from the plurality of electrodes by greater than 0.1 mm.

7. A fiber optic gyroscope, comprising:
a light source for generating light;
a fiber coil through which the light is transmitted; and
an optical phase modulator for modulating the light, wherein the optical phase modulator includes: a lithium niobate substrate, a proton-exchanged waveguide section formed on the substrate, and a zinc oxide diffused stitched-in waveguide section formed on the substrate and optically coupled to the proton-exchanged waveguide section.

8. A gyroscope as claimed in claim 7, wherein the proton-exchanged waveguide section comprises a Y-junction, a first branch waveguide portion, and a second branch waveguide portion.

9. A gyroscope as claimed in claim 8, wherein the zinc oxide diffused stitched-in waveguide section comprises a first stitched-in waveguide portion optically coupled to the first branch waveguide portion, a second stitched-in waveguide portion optically coupled to the second branch waveguide portion, and a plurality of electrodes proximate to the first and second stitched-in waveguide portions.

10. A gyroscope as claimed in claim 9, wherein the proton-exchanged waveguide section further comprises a first distal side waveguide portion coupled to the first stitched-in waveguide portion; and a second distal side waveguide portion coupled to the second stitched-in waveguide portion.

11. A gyroscope as claimed in claim 9, wherein the first and second zinc oxide diffused stitched-in waveguide portions extends substantially parallel to crystal planes of the substrate.

12. A gyroscope as claimed in claim 9, wherein coupling locations between the zinc oxide diffused stitched-in waveguide section and the proton-exchanged waveguide section are separated from the plurality of electrodes by greater than 0.1 mm.

13. A method of fabricating an optical phase modulator, comprising:
providing a lithium niobate substrate;
forming a proton-exchanged waveguide section on the substrate; and
forming a zinc oxide diffused stitched-in waveguide section on the substrate that is optically coupled to the proton-exchanged waveguide section.

14. A method as claimed in claim 13, wherein forming the proton-exchanged waveguide section comprises forming a Y-junction, a first branch waveguide portion, and a second branch waveguide portion.

15. A method as claimed in claim 14, wherein forming the zinc oxide diffused stitched-in waveguide section comprises forming a first stitched-in waveguide portion optically coupled to the first branch waveguide portion, forming a second stitched-in waveguide portion coupled to the second branch waveguide portion, and forming a plurality of electrodes proximate to the first and second stitched-in waveguide portions.

16. A method as claimed in claim 15, wherein forming the proton-exchanged waveguide section further comprises forming a first distal side waveguide portion optically coupled to the first stitched-in waveguide portion; and forming a second distal side waveguide portion optically coupled to the second stitched-in waveguide portion.

17. A method as claimed in claim 15, wherein the first and second zinc oxide diffused stitched-in waveguide portions extend substantially parallel to crystal planes of the substrate.

18. A method as claimed in claim 15, wherein coupling locations between the zinc oxide diffused stitched-in waveguide section and the proton-exchanged waveguide section are separated from the plurality of electrodes by greater than 0.1 mm.
